(19) United States
(12) Patent Application Publication
(10) Pub. No.: US 2010/0153178 A1
(43) Pub. Date: Jun. 17, 2010

(54) SYSTEM FOR DETERMINING THE INTRINSIC VALUE PROVIDED TO INTERNET USERS BY SELECTED WEB SITES

(75) Inventor: Travis Russell, Columbia, MO (US)

Correspondence Address: PATTON BOGGS LLP, 1801 CALFORNIA STREET, SUITE 4900, DENVER, CO, 80202, US

(73) Assignee: WebbChange, LLC, Columbia, MO (US)

(21) Appl. No.: 12/335,063

(22) Filed: Dec. 15, 2008

(51) Int. Cl. G06Q 10/00; G06Q 30/00; G06Q 50/00

(52) U.S. Cl. 705/10; 705/14.32

(57) ABSTRACT

The WEB Site Valuation System identifies each user's personal attribution of value to a selected WEB site. The attribution is constrained by assigning each user a predetermined number of assignable credits/tokens from which the user can draw to “deposit” or “withdraw” previously deposited credits in the “account” of a WEB site. The tally of credits for each WEB site is then a direct indication of the value provided to users. This ultimately creates a token economy for and within the WEB, based upon user opinion of the value of WEB sites. The dynamic mapping and correlation of these value indications with the users' characteristics provides analytical data that can be used to determine the relevance of the WEB site to various socio-demographic populations, as well as the response of the users to changes in the WEB site, market forces, and/or the entire community of WEB sites.

### CROSS-REFERENCE TO RELATED APPLICATIONS

This Application is related to a U.S. application titled “System For Determining The Intrinsic Value Provided To Internet Users By Selected Web Sites”, filed on the same date as the present application and incorporating the disclosure herein.

### FIELD OF THE INVENTION

This invention relates to the Internet and, in particular, to a system for tracking the value that Internet users ascribe to various WEB sites.

### BACKGROUND OF THE INVENTION

It is a problem to determine the “worth” to Internet users of WEB sites that the Internet users visit. A common metric used to determine the value of a particular WEB site is termed “eyeballs”, which identifies the number of times the WEB site is accessed by users. Other metrics are the number of screens in the WEB site that the user accesses, the duration of the viewing of each screen, the duration of the entire session on the WEB site, and other similar measurements.

The difficulty with all of these metrics is that they are inferential, in that they presume that the measured parameter is somehow indicative of the interest shown by the Internet user and/or the value delivered to the Internet user by the visited WEB site. However, such a presumption is not always valid, and the measurements are imprecise at best. A user can leave their computer logged on to a selected WEB site while the user is performing other tasks. The user may be scrolling through a WEB site with idle curiosity. The information obtained by the user may be of marginal value to the user or may be of great importance to the user. The time required to obtain the information does not necessarily have any correlation to the value of the information and, in many cases, simply reflects the quality or lack thereof of the design of the WEB site.

Thus, there is a need for some credible and direct determination of the value provided by selected WEB sites to the users who visit these WEB sites. This information is valuable not only to the user community but also to advertisers, investors, financial institutions, and the company that hosts the WEB site. Most importantly, this information is valuable to the users of the WEB trying to locate specific sites and information that is credible and of high quality.

### BRIEF SUMMARY OF THE INVENTION

These problems are solved and a technical advance achieved in the art by the present System For Determining The Intrinsic Value Provided To Internet Users By Selected Web Sites (termed “WEB Site Valuation System” herein) which implements a process that identifies each user's personal attribution of value to the particular user's session that executed on the selected WEB site.

The attribution of value by the user is constrained thereby to motivate the user to make an accurate and reasonable assignation of value. This is accomplished by assigning each user a predetermined number of assignable credits/tokens (such as “coins”) from which the user can draw to “deposit” or “withdraw” previously deposited credits in the “account” of a visited WEB site or any WEB site they list. The limited number of credits typically causes the user to be judicious in the allocation of credits to avoid exhausting their supply of credits. In addition, the user's motivation to participate in this real-time rating system is stimulated by the availability of rewards, incentives, and positive reinforcements to users who participate in this process. The tally of credits for each WEB site and the number of credits assigned by each user then are direct indications of the value provided to the users who visited the WEB site. This ultimately creates a token economy for and within the WEB based upon user opinion of the value of WEB sites. The dynamic mapping of these value indications and the correlation of these value indications with the characteristics of the users provides a tremendous amount of analytical data that can be used to determine the relevance of the WEB site to various socio-demographic populations, as well as the response of the users to changes in the WEB site, market forces, and/or the entire community of WEB sites. This system can provide temporal snapshots of the worth of WEB sites as well as dynamic longitudinal indications of value in response to some stimulus, all correlated by user demographics.

The user accesses the webbchange.com WEB site either directly by entering the URL of the WEB Site Valuation System into the browser of their Internet-connected computer, linking to webbchange.com through a URL of another site, or having a WEB Site Valuation System plug-in operational on their computer. In any case, the user can access their account on the WEB Site Valuation System.

### BRIEF DESCRIPTION OF THE DRAWINGS

FIG. 1 illustrates, in block diagram form, the overall architecture of a data communications network which provides connectivity between the Internet-based resources and services and the users of those facilities, including the present WEB Site Valuation System;

FIG. 2 illustrates, in block diagram form, the architecture of the webbchange.com segment of the present WEB Site Valuation System;

FIG. 3 illustrates, in flow diagram form, the operation of the user registration process of the webbchange.com segment of the present WEB Site Valuation System;

FIG. 4 illustrates, in block diagram form, the architecture of the Webbxchange.com segment of the present WEB Site Valuation System;

FIG. 5 illustrates, in flow diagram form, the operation of the user registration process of the Webbxchange.com segment of the present WEB Site Valuation System;

FIG. 6 illustrates a graphic example of a typical screen from the WEB site of the present WEB Site Valuation System;

FIGS. 7A-7C illustrate graphic examples of typical screens from the new user create and activate process of the present WEB Site Valuation System;

FIG. 8 illustrates a graphic example of a typical screen from the My Home process of the present WEB Site Valuation System;

FIGS. 9A-9D illustrate graphic examples of typical screens from the user profile data entry portion of the present WEB Site Valuation System;

FIGS. 10A and 10B illustrate graphic examples of typical screens from the portfolio data entry portion of the preferences process of the present WEB Site Valuation System;

FIG. 11 illustrates a graphic example of a typical screen from the search process of the present WEB Site Valuation System;

FIG. 12 illustrates, in block diagram form, the functional elements contained in the credit management process; and

FIGS. 13 and 14 illustrate, in flow diagram form, the operation of tailoring the home page process from the setting section 904 of profile section 203.

### DETAILED DESCRIPTION OF THE INVENTION

### Internet and World Wide Web Architecture and Functionality

The terms “Internet” and “World Wide Web” are often used in everyday speech without much distinction. However, the Internet and the World Wide Web (also termed “Web” herein) are not one and the same. The Internet is the physical backbone of the World Wide Web, i.e., the underlying global data communications network, including the hardware and software infrastructure. It provides connectivity between the Internet-based resources and services and the users of those facilities. The Internet is a global system of interconnected computer networks that interchange data by packet switching using the standardized Internet Protocol Suite (TCP/IP). It is a “network of networks” that consists of millions of private and public, academic, business, and government networks of local to global scope that are linked by copper wires, fiber-optic cables, wireless connections, and other technologies. The Internet carries various information resources and services, such as electronic mail, online chat, file transfer and file sharing, online gaming, and the inter-linked hypertext documents and other resources of the World Wide Web (WWW).

In contrast, the World Wide Web is only one of the services communicated via the Internet, and it comprises a collection of interconnected documents and other resources connected by symbolic links, e.g., hyperlinks and URLs. These hyperlinks and URLs allow the web servers and other machines that store originals and cached copies of these resources to deliver them to users as required using HTTP (Hypertext Transfer Protocol). HTTP is only one of the communication protocols used on the Internet. Web services also use HTTP to allow software systems to communicate in order to share and exchange business logic and data.

Software products that can access the resources of the Web are termed “user agents”. In normal use, web browsers (a form of user agent) access web pages and allow users to navigate from one to another via hyperlinks. Web documents may contain almost any combination of computer data including graphics, sounds, text, video, multimedia, and interactive content, including games, office applications, and scientific demonstrations. In the present description, a WEB site is an Internet-based server which presents a user, who is connected to this Internet-based server via a user communication device, with content in the form of data and/or services.

### Marketing

The Internet is a large market for companies. Some of the biggest companies today have grown by taking advantage of the efficient nature of low-cost advertising and commerce through the Internet, also known as e-commerce. It is the fastest way to simultaneously spread information to a vast number of people. The Internet has also revolutionized shopping. For example, a person can order a CD online and receive it in the mail within a couple of days, or instantaneously download its contents. The Internet has also greatly facilitated targeted or personalized marketing, which allows a company to market a product to a specific person or a specific group of people, more so than any other advertising medium.

However, it is a problem to determine the “worth” to Internet users of WEB sites that the Internet users visit. A common metric used to determine the value of a particular WEB site is termed “eyeballs”, which identifies the number of times the WEB site is accessed by users. Other metrics are the number of screens in the WEB site that the user accesses, the duration of the viewing of each screen, the duration of the entire session on the WEB site, and other similar measurements.

The difficulty with all of these metrics is that they are inferential, in that they presume that the measured parameter is somehow indicative of the interest shown by the Internet user and/or the value delivered to the Internet user by the visited WEB site. However, such a presumption is not always valid, and the measurements are imprecise at best. A user can leave their computer logged on to a selected WEB site while the user is performing other tasks. The user may be scrolling through a WEB site with idle curiosity. The information obtained by the user may be of marginal value to the user or may be of great importance to the user. The time required to obtain the information does not necessarily have any correlation to the value of the information and, in many cases, simply reflects the quality or lack thereof of the design of the WEB site.

### Network Architecture

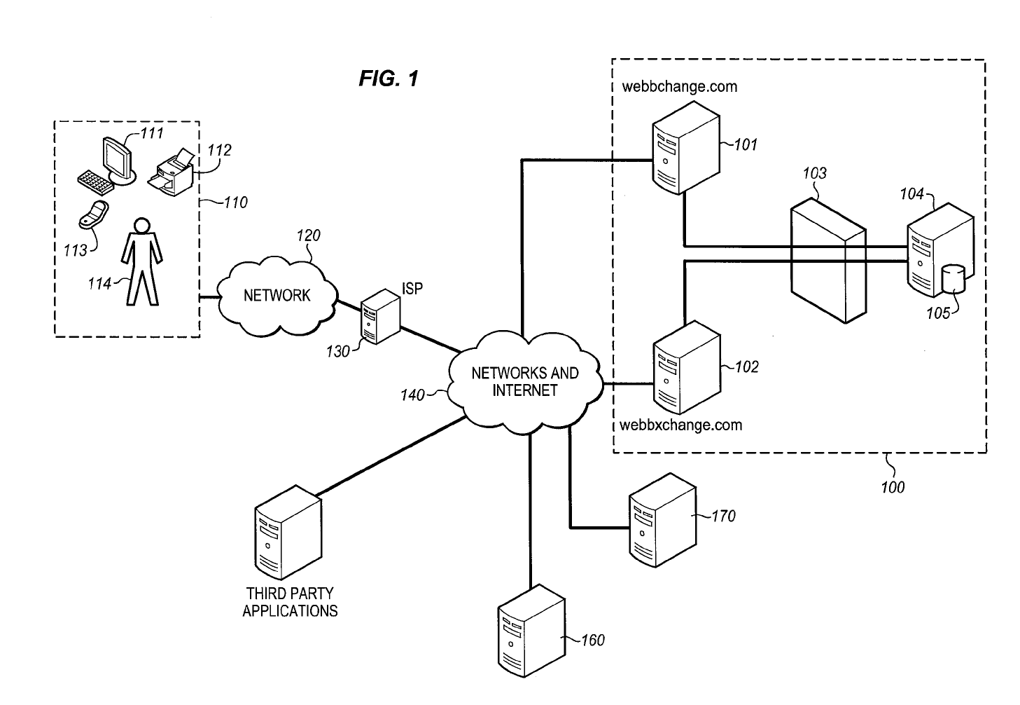

FIG. 1 illustrates, in block diagram form, the overall architecture of a data communications network which provides connectivity between the Internet-based resources and services and the users of those facilities, including the present WEB Site Valuation System 100. In particular, a user 114 who is equipped with at least one electronic device (such as computer 111, printer/fax/scanner 112, cell phone 113, and the like—collectively termed “user equipment 110”) is connected via a communication medium 120 (such as wire line, cable television, satellite, cellular, and the like) to an Internet Service Provider (ISP) 130 which interconnects the user with a data communication network 140 (termed “Internet” herein). The Internet 140, as noted above, is a hardware and software backbone which enables the user 114 to access selected ones of servers 101, 102, 150-170 which host various applications and WEB sites.

Two such WEB sites are noted as webbchange.com 101 and webbxchange.com 102, which are a part of the present WEB Site Valuation System 100. The WEB Site Valuation System 100 also includes one or more database servers 104, which provide a secure environment for the storage and processing of data associated with the applications described herein. The database servers 104 (also referred to as “databases”) can be implemented by a cluster of servers; and, if necessary, the WEB Site Valuation System 100 can also be equipped with data storage facilities 105, typically termed “mass storage systems”, which serve to store mass quantities of customer data.

A Firewall 103 is also provided to prevent access to the databases 104 except for the authorized applications. The WEB servers 101, 102 respond to requests from browsers and process the request and store and retrieve data on the associated databases 104 as required.

### Webbchange.com New User Registration

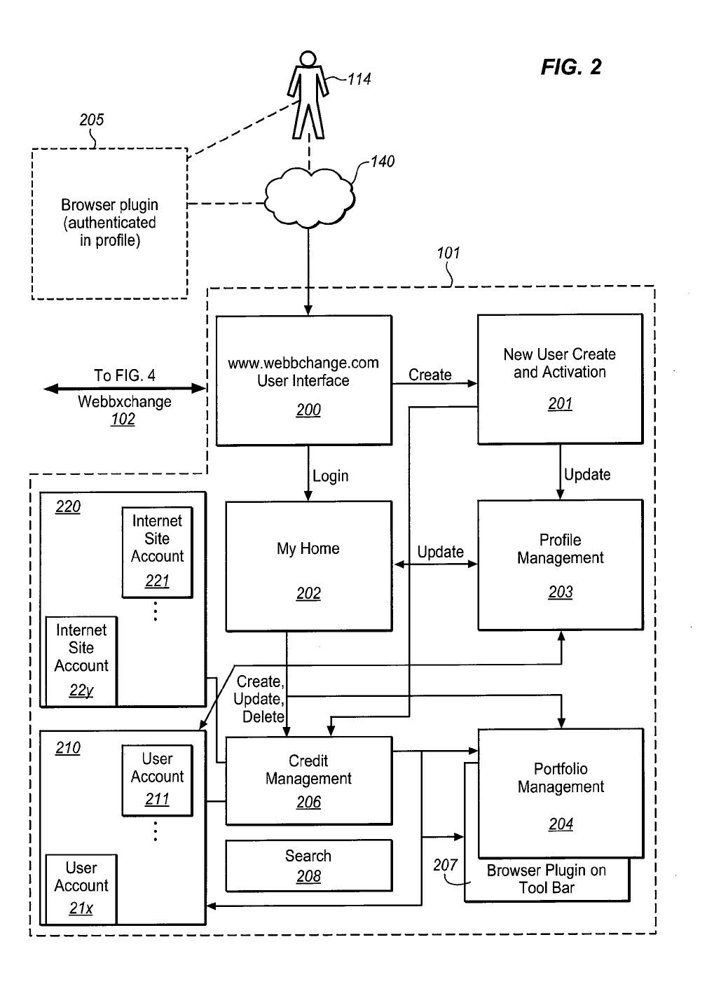

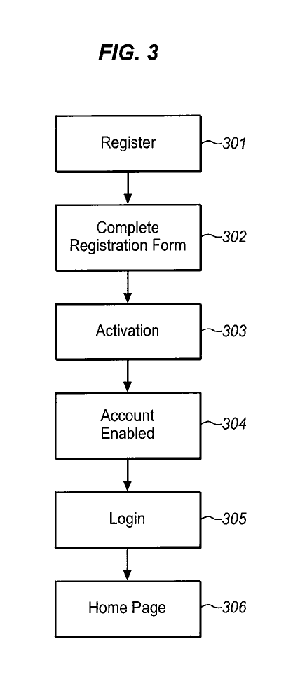

FIG. 2 illustrates, in block diagram form, the architecture of the webbchange.com portion of the present WEB Site Valuation System 100; and FIG. 3 illustrates, in flow diagram form, the operation of the user registration process. The WEB Site Valuation System 100 includes a number of functional elements, and FIG. 2 illustrates those used to implement the www.webbchange.com 101 WEB site.

The www.webbchange.com 101 WEB site includes a plurality of user accounts 211-21x, one for each user 114 who registers with the www.webbchange.com 101 WEB site. These user accounts 211-21x (in user account memory 200) are each connected to a credit management process 206 and portfolio management process 204, which regulate the assignment and distribution of credits to and from the user accounts 211-21x. The www.webbchange.com 101 WEB site also includes a plurality of Internet site accounts 221-22y, one for each WEB site that registers with the www.webbchange.com 101 WEB site. The credit management process 206 also is connected to the Internet site accounts 221-22y (stored in Internet site memory 220) to regulate the assignment and distribution of credits from the user accounts 211-21x to and among the Internet site accounts 221-22y. The credit management process 206 can be implemented as part of the browser 205 or as part of various components of the www.webbchange.com 101 WEB site (such as portfolio management 204), or it can be implemented as a separate process. For the purpose of illustration, the credit management process 206 is described herein as a separate process which receives input data from the new user create and activate process 201 and the my home process 202.

### Credit Management Process

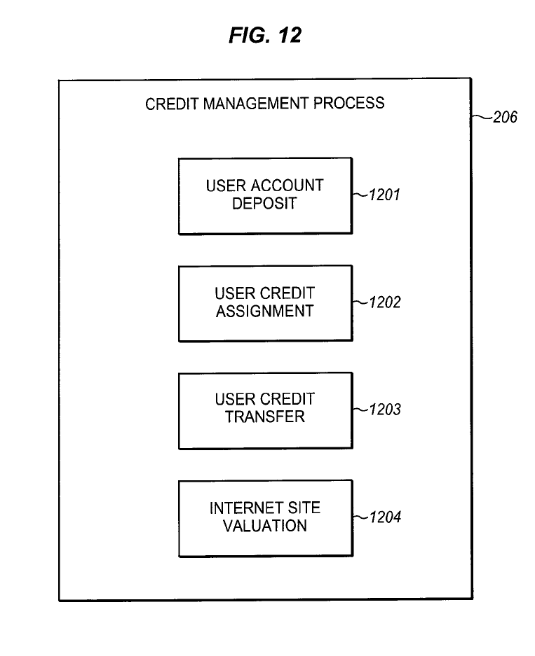

FIG. 12 illustrates, in block diagram form, the functional elements contained in the credit management process 206. The credit management process 206 implements a number of functions for the associated plurality of user accounts 211-21x and Internet site accounts 221-22y. These functions include: user account deposit 1201, user credit assignment 1202, user credit transfer 1203, and Internet site valuation 1204. There are numerous ways of managing the deposit of credits into a user account, and the one described herein makes use of a fixed number of credits paradigm, wherein each user is assigned a fixed number of credits to be allocated among Internet sites as the user so chooses. This enables each user to have an equal input on the valuation of Internet sites. The credits are deposited into the user account in predefined segments as the user proceeds through the registration and profile creation processes. Thus, as described herein, the user account deposit 1201 process receives confirmation of the completion of the registration process from the new user account creation and activation process 201 and from the profile management process 203 and deposits the predetermined credits into the user account.

The user credit assignment 1202 process is responsive to a user allocating credits from their account to a designated Internet site for transferring these credits from the user's account to the Internet site account corresponding to the selected Internet site. Similarly, the user credit transfer 1203 process enables the user to reallocate credits among Internet sites. Thus, the user can manage their credits after they have been assigned to Internet sites to reflect the changing opinions of the user.

Finally, the Internet site valuation 1204 process performs the credit tabulation function to maintain a current tally of the credits in each of the Internet site accounts 221-22y, which data is used by the webbxchange.com 102 component of the WEB Site Valuation System 100 to generate reports of the relative valuation of the Internet sites, as described below. The term “tabulate” includes all forms of computation, including maintaining a sum of all credits assigned to a WEB site, maintaining data indicative of how many credits are assigned to a WEB site by a user, data averages, and other statistical analyses of the raw data that is collected. The tabulation is not only performed on a per WEB site basis but is performed across all WEB sites as well as across WEB sites as grouped by category or topic area. The tabulation can be performed as a process so data is available to all users or can be performed pursuant to a request received from a particular user or site administrator or advertiser.

In particular, a user 114 can access this WEB site via a communication medium 140 in the standard manner to connect to the user interface process 200 and, if the user 114 is a first time user, navigate to the new user create and activate process 201. This new user create and activate process 201 enables the user 114 to create a user account (for example, user account 211) for the user 114 in the webbchange.com 101 domain and can use the e-mail address of the user 114 as their unique identifier, as described below. When the user 114 registers with the www.webbchange.com 101 WEB site, the new user create and activate process 201 transmits new user data to the credit management process 206, which creates a new user account 211 for this user 114. As part of the account creation process, the user 114 receives some predetermined number of credits for the creation of a new user account, and these credits are deposited into user account 211 by the credit management process 206. The user 114 is also prompted to populate their user account 211, via profile management process 203, with data regarding their profile: basic information, personal information, interests, and other relevant information ranging from demographics to other qualities unique to an individual. The user 114 earns more credits as they complete their profile, earning all potential credits upon 100% completion of their profile. The profile management process 203 transmits the profile data to the user account 211 as well as an indication of the profile population/completion activity of the user 114 to credit management process 206 thereby to authorize the deposit of additional credits into the user account 211.

Once the user 114 has an account with webbchange.com 101, their entry into the WEB site is via the user interface 200 and login process 202 to a “My Home” page through which the user 114 can access their profile via profile management process 203 to update the data contained therein. The user 114 also can access the portfolio management process 204, which enables the user 114 to create a portfolio of URLs, which the user 114 accesses on a regular basis. This portfolio data is stored in the user account 211. This process also enables the user 114 to allocate credits to the URLs listed in this portfolio via the credit management process 206.

The user 114 also can access their portfolio via the use of a browser plug-in 205 which is resident on the user's computer 111. Thus, when the user 114 has their browser activated and their computer 111 is connected to the Internet 140, the webbchange.com plug-in 205 resident on the user's computer 111 can access the user's portfolio 211 via a link to the webbchange.com 101 WEB site.

Typical Screen from the WEB Site

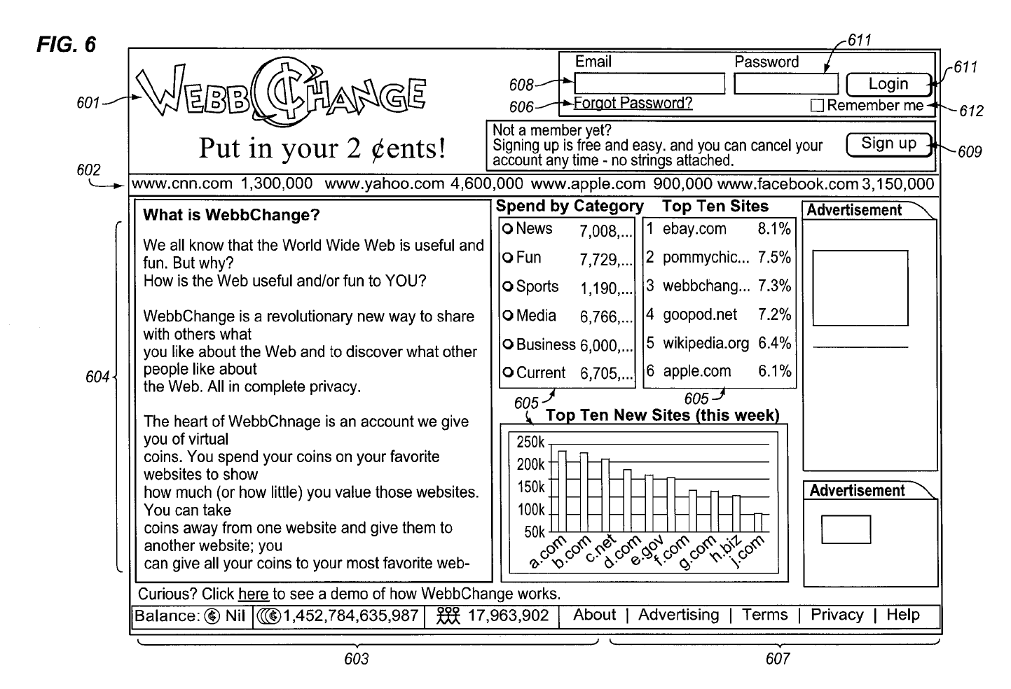

FIG. 6 illustrates a graphic example of a typical screen from the WEB site of the present WEB Site Valuation System; and FIG. 3 illustrates, in flow diagram form, the operation of the new user create and activate process 201 of the present WEB Site Valuation System 100. At step 301, the user 114 can access the webbchange.com 101 WEB site via a communication medium 140 in the standard manner. Once connected to the webbchange.com 101 WEB site, the user 114 is presented with a WEB page by the user interface 200, typically one as shown in FIG. 6. This display includes information items and data entry fields, as well as icons which can be selected to navigate away from this page to other pages hosted by this WEB site. In particular, the users can be divided into three categories: visitors, new users, and registered users. The information fields 601-605 and 607 can be used by a visitor to identify the site owner (601) and obtain further information about the site owner and site practices (607) or webbchange.com (604). In addition, several news displays (602, 603, and 605) are provided to indicate current activity that relates to webbchange.com and its user population. The site-wide link directory (607) also is provided to enable the visitor to browse through the public areas of the webbchange.com WEB site. New users have a Sign up!” icon (609) through which they can access the new user registration process as is described herein. Finally, existing users can log in using the login (610) icon by first entering their information into the email (608) and password (611) data entry fields. An existing user may access the forgotten password process (606) or may use the “remember me” indicator (612) to allow a user to skip through www.webbchange.com (101) and directly link to the User homepage (202) when visiting www.webbchange.com again in the future.

Typical Screen from the New User Create and Activate Process

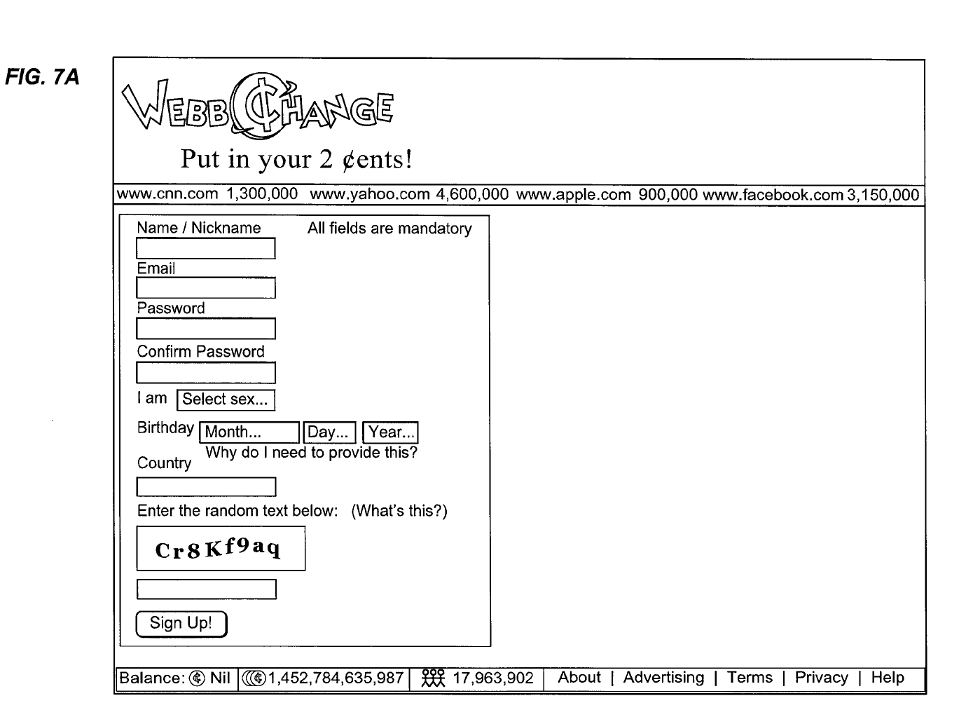

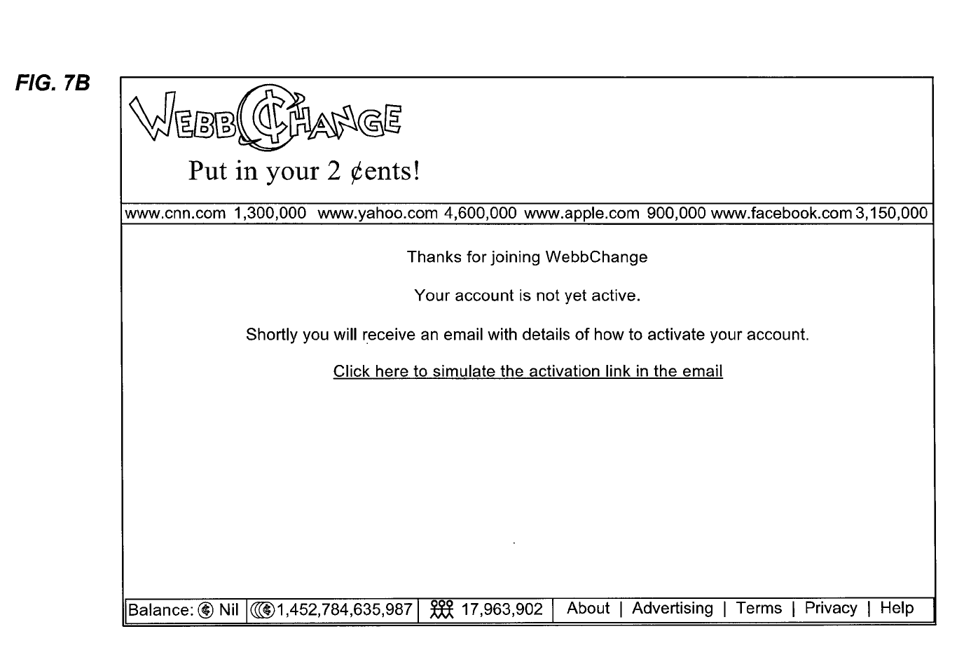

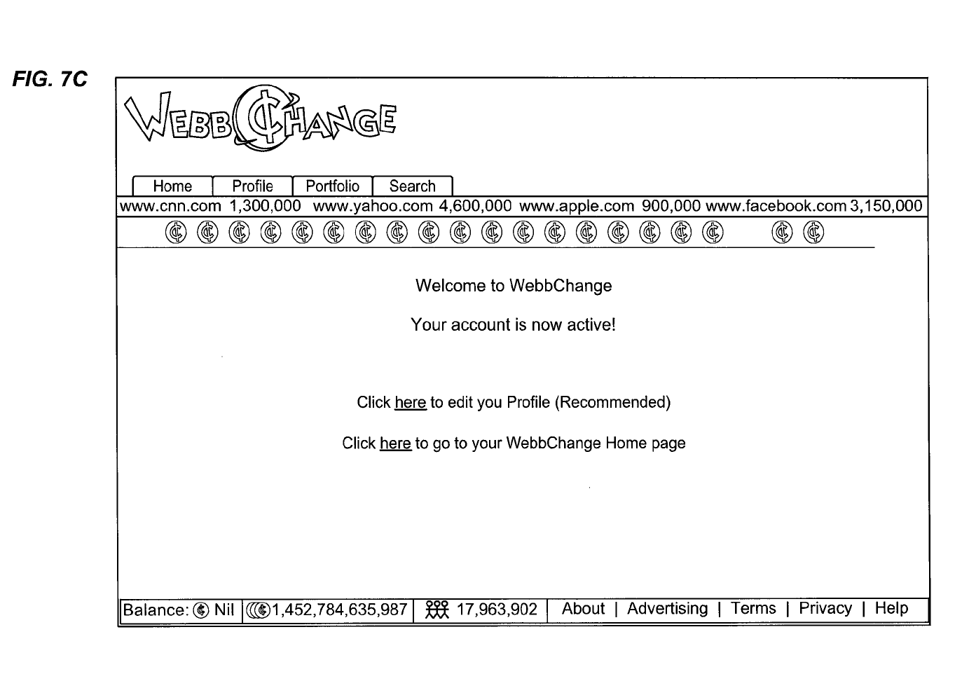

FIGS. 7A-7C illustrate graphic examples of typical screens from the new user create and activate process of the present WEB Site Valuation System. If the user 114 is a first time user, the user 114 clicks on the new user icon to navigate to the new user create and activate process 201. This process 201 at step 302 (FIGS. 7A and 7B) creates an account for the user 114 in the webbchange.com 101 domain. The new user create and activate process 201 presents the user 114 with a registration page that includes a combination of mandatory data entry fields and optional data entry fields. These data entry fields represent basic user identification and limited demographic information about the new user that enables the WEB Site Valuation System to uniquely identify the new user.

As part of the process of creating a new user login and profile, the user 114 is requested to create a unique login and password. For example, the user 114 uses their e-mail address as their unique identifier. In addition, the user 114 is required to validate a randomized, alphanumeric string, which is presented as an image.

### CAPTCHA

A method to block automated spam access to a system is by requiring a human-generated validation of the access form prior to enabling access. The goal of this process is to verify that the form is being submitted by a real human being and not by a spam tool. This process is referred to as a reverse Turing test. The test should be of such a nature that a human being can easily pass and an automated tool would most likely fail.

For example, many forms on websites take advantage of the CAPTCHA (Completely Automated Public Turing test to tell Computers and Humans Apart) technique, displaying a combination of numbers and letters embedded in an image which must be entered literally into the reply form to pass the test. In order to keep out spam tools with built-in text recognition, the characters in the images are customarily misaligned, distorted, and noisy. CAPTCHA, therefore, is a challenge-response test which ensures that the response is not generated by a computer. The process usually involves one computer (a server) asking a user to complete a simple test, which the computer is able to generate and grade. Because other computers are unable to solve the CAPTCHA, any user entering a correct solution is presumed to be human. Thus, it is sometimes described as a reverse Turing test, because it is administered by a machine and targeted to a human, in contrast to the standard Turing test that is typically administered by a human and targeted to a machine.

### E-Mail Notification of Activation Link/Code

Once the user 114 completes the registration form, the corresponding user account 211 has deposited therein a predetermined number of credits by the credit management process 206, and the user 114 receives an e-mail from webbchange.com 101 that contains an activation link or code. The user 114 cannot log into the user's account on webbchange.com 101 until the account has been activated by the link, code, or trusted third party mechanism (such as biometric scanning) which is executed at step 304 (shown in FIG. 7C). Upon activation of the user account using the account enabling process of step 304, the user 114 receives a follow-up notice from webbchange.com 101 informing them that their account has been activated and they can now log into their account and start using the application. From step 304, a user may continue on to the profile management process 203 or connect to their user homepage 202.

### Types of Credits

This application describes the management of credits, which can be termed “coins” or any such well-known term. These credits can be issued in various categories in order to differentiate the user's intent in assigning them to Internet sites. In particular, there can be standard currency credits that are used to indicate the value of an identified Internet site. There also can be charity credits, which can only be used on charity Internet sites. The charity credits are unique in that:
1. A portion of the profits can be donated to charities based on the charity credits issued to each charity Internet site.
2. The charity credits bring awareness to various charities which are deemed to be of value to the users based upon their assignment of charity credits to these charities.
3. Users can potentially earn additional charity credits pursuant to some process which rewards users for contributions and/or participation in the Internet site valuation process.

There can also be credits specifically for other uses as determined by the operators of the WEB Site Valuation System 100. These can be directed to advertisements, product evaluations, and the like, in order to enable the users to evaluate more than Internet sites.

Typical Screen from the My Home Process

As stated previously, at step 305 the user 114 can log in to webbchange.com 101 using their unique login and password to reach the home page 202 through which the user 114 can access their profile 203 to update the data contained therein. The user 114 also can access the portfolio process 204, which enables the user 114 to create a portfolio of URLs, which the user 114 accesses on a regular basis. This portfolio process 204 also enables the user 114 to allocate credits to the URLs listed in this portfolio. Also from homepage 202, a user can access the search engine 208 to do dynamic searches based on information gathered from the webbchange.com 101 user base.

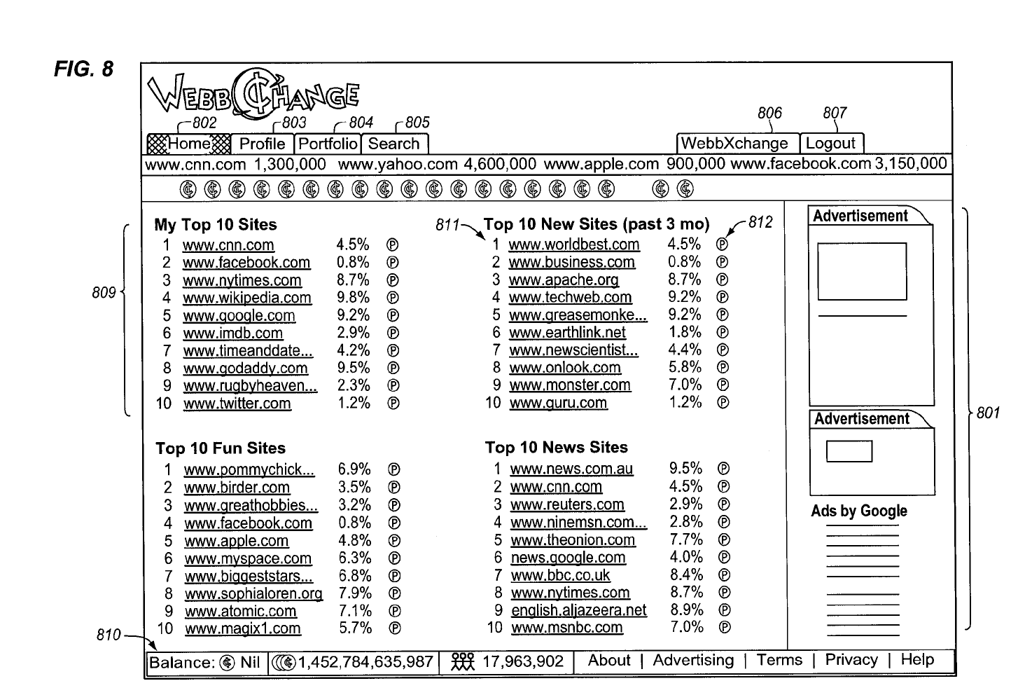

FIG. 8 illustrates a graphic example of a typical screen 800 from the My Home process 202 of the WEB Site Valuation System 100. From this page a user 114 can click various icons to navigate to other pages. These icons are the profile icon 803, portfolio icon 804, search icon 805, webbxchange.com icon 806, logout icon 807, any of the category icons 808, as well as site links standard in 607. FIG. 8 also shows the various user boards 809 which are lists of WEB sites grouped by topic or user interest, relevant advertising 801, and the account balance 810 of user 114. The user 114 can also access a URL profile page by clicking on the URL profile icon 812 located next to any URL link 811.

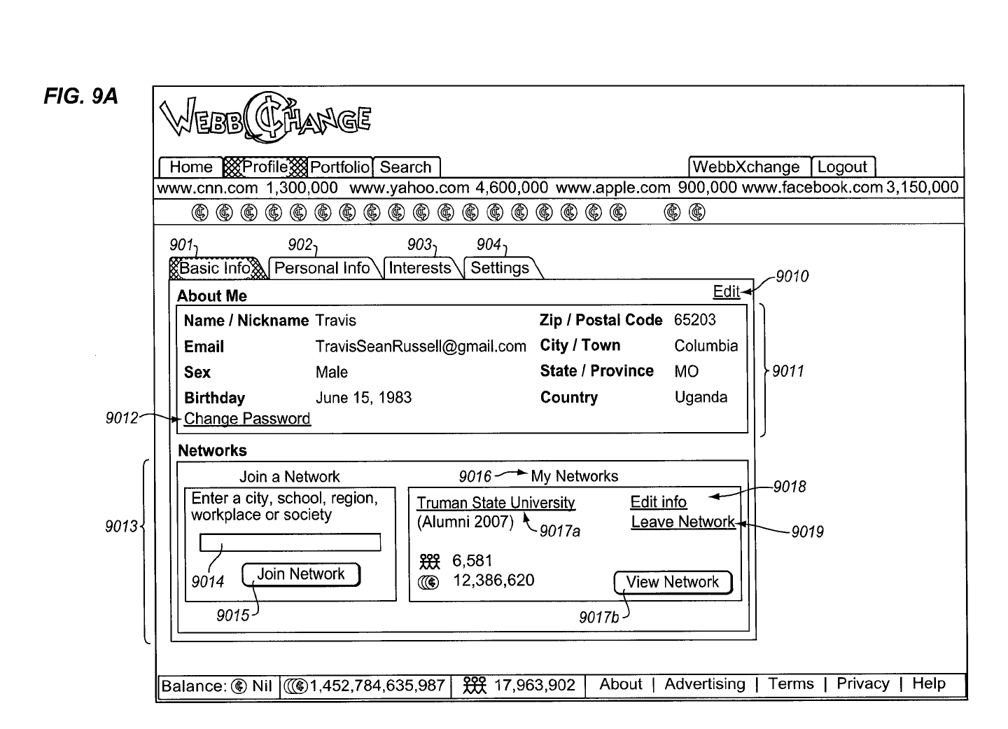

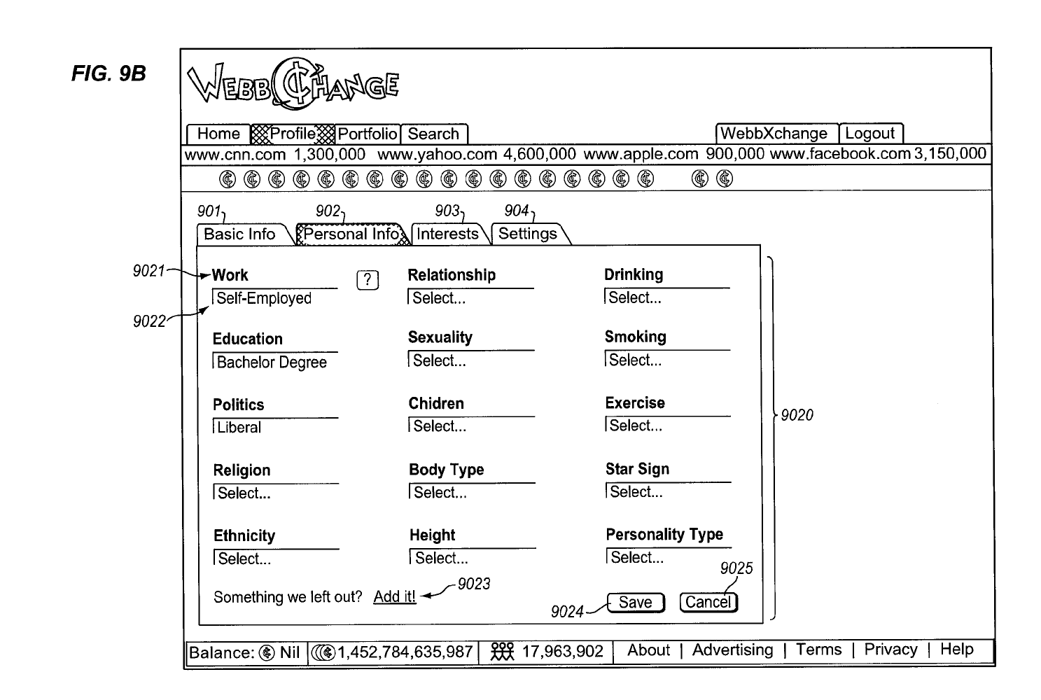

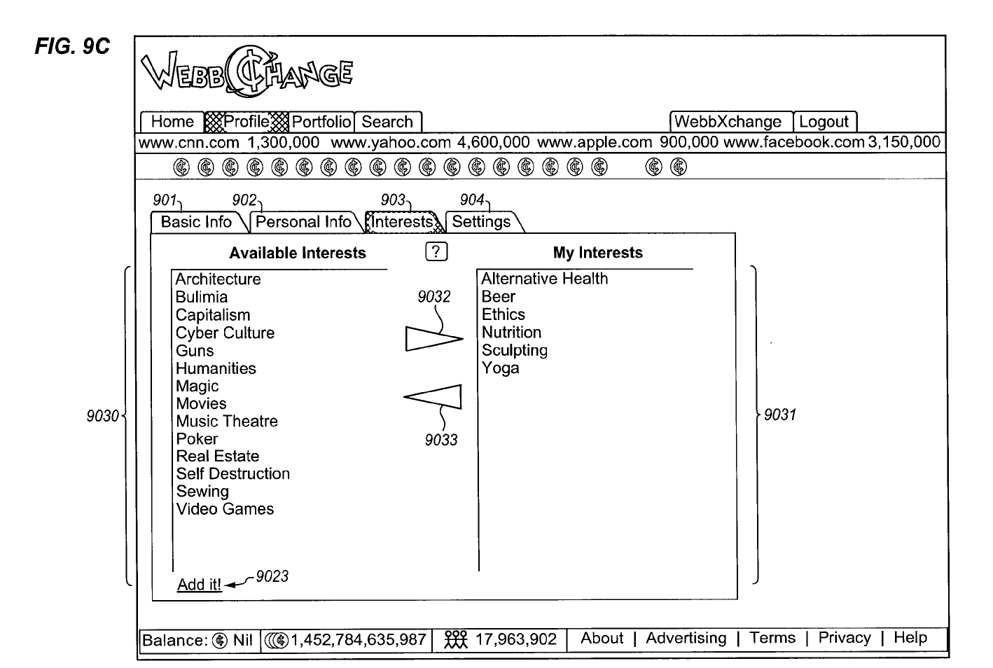

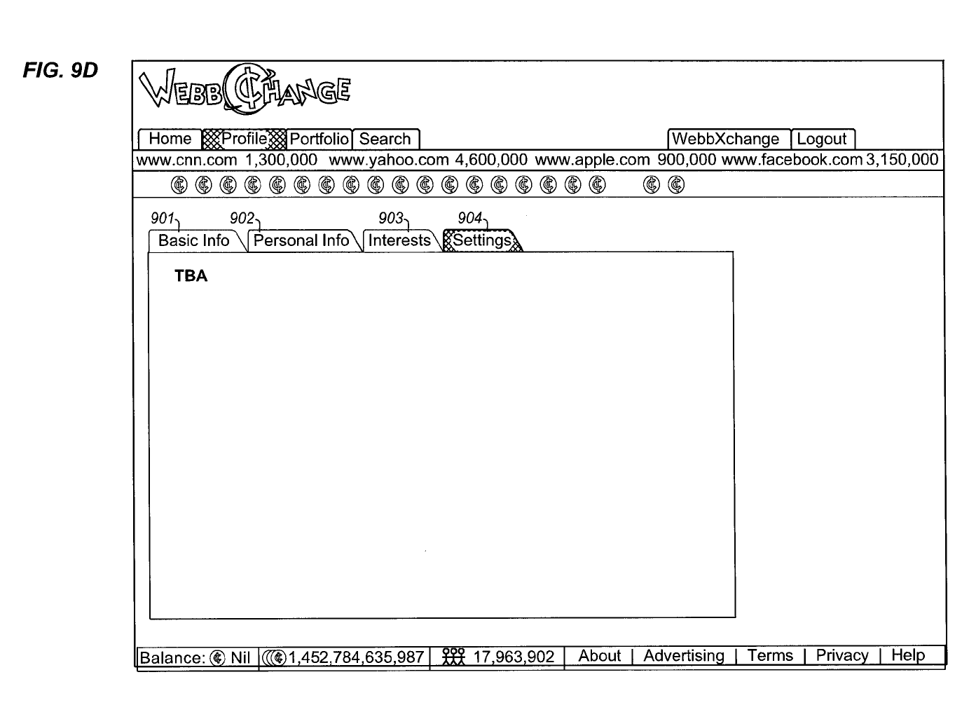

The profile icon 803 allows the user 114 to navigate to the profile screen and enter/update their profile information to capture the basic information, personal information, interests, and settings of the user 114. This information is detailed in section 203 found in FIGS. 9A-9D.

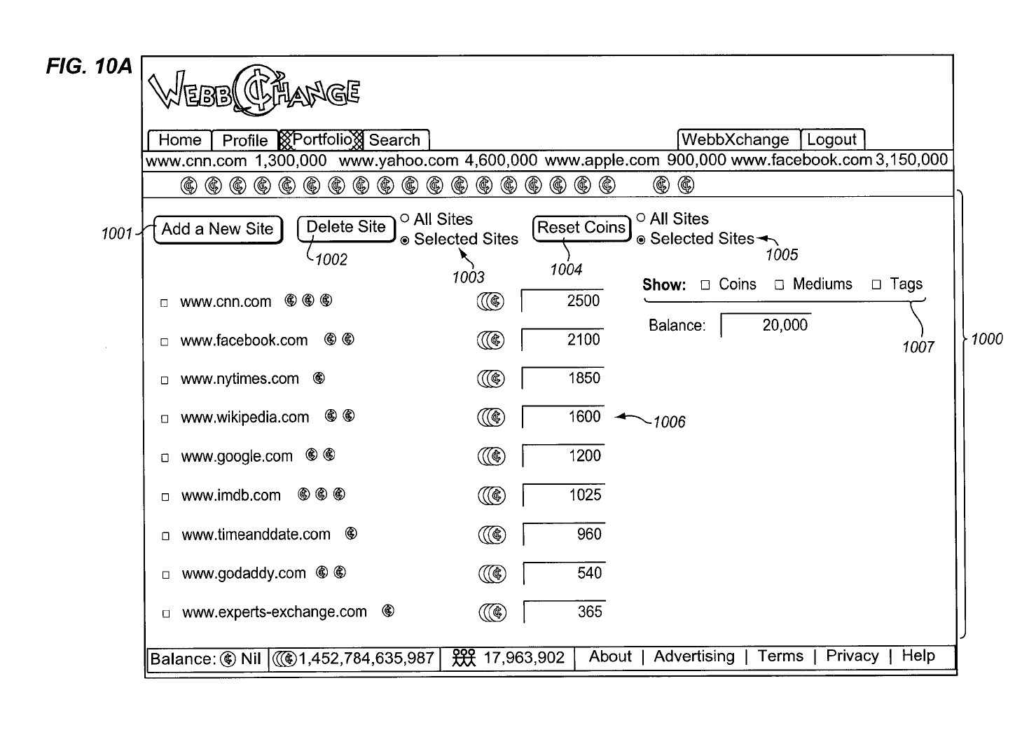

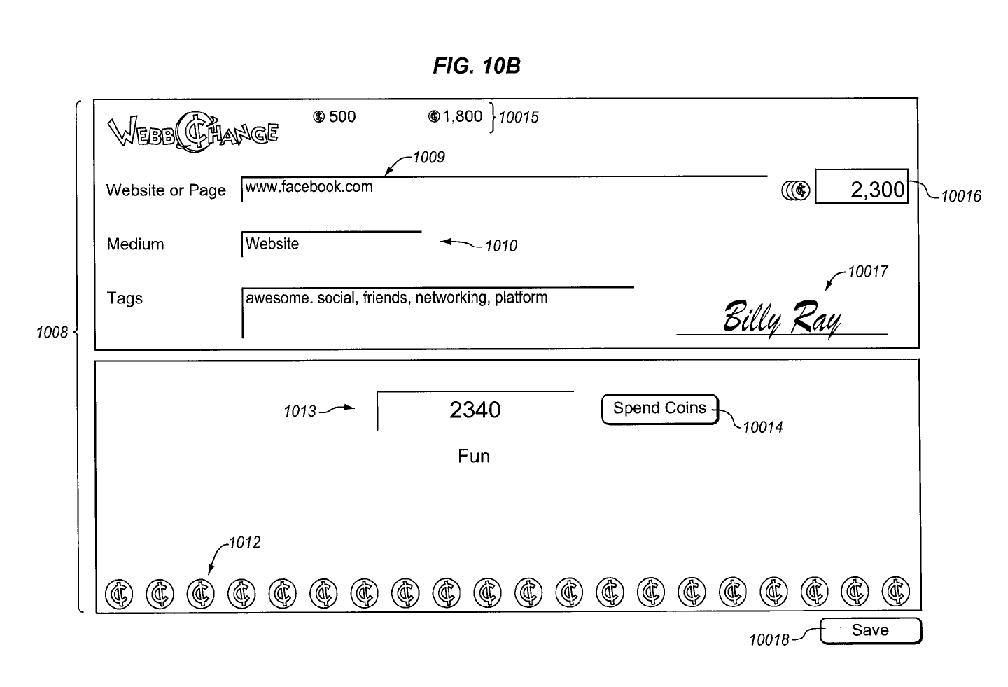

The portfolio icon 804 allows the user 114 to navigate to the portfolio screen and view, enter, and update the portfolio information of the user 114. This information is detailed in section 204 found in FIGS. 10A and 10B.

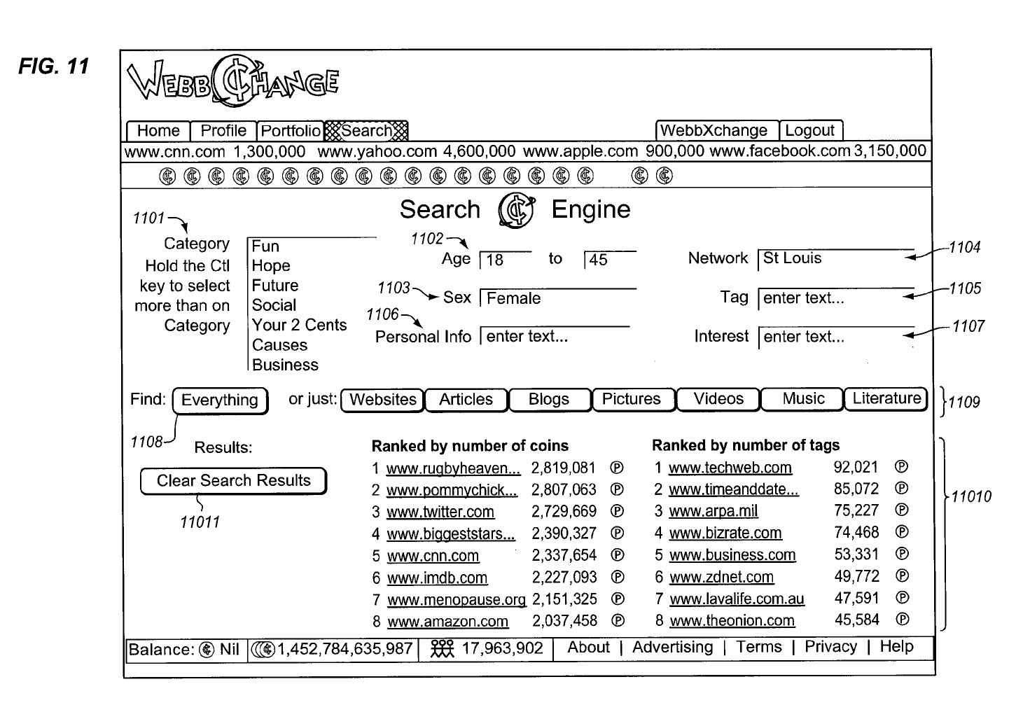

The Search icon 805 allows the user 114 to navigate to the search screen and conducts searches detailed by the user 114. This information is detailed in section 205 found in FIG. 11.

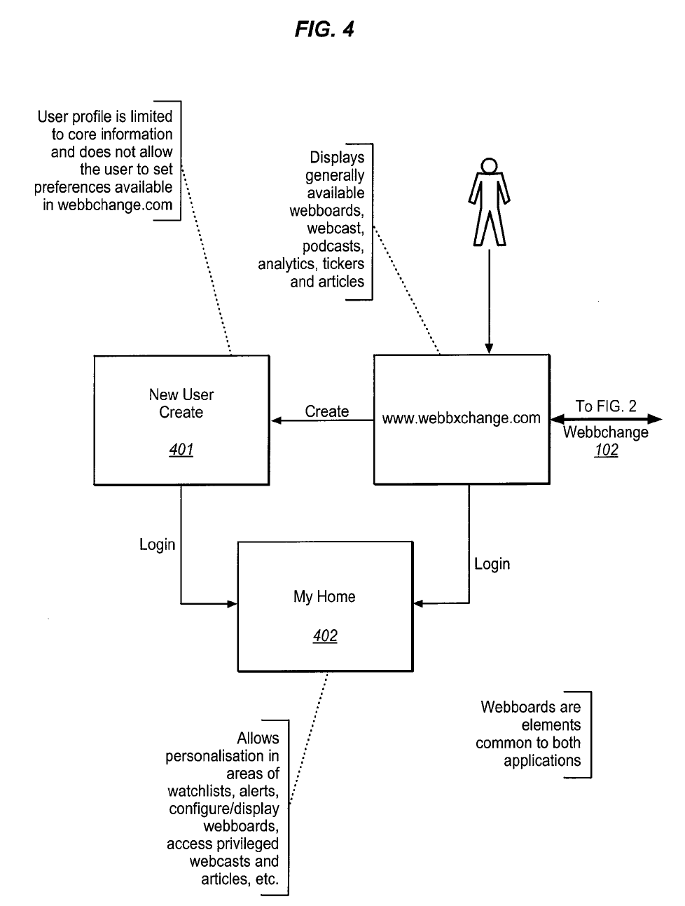

The webbxchange.com icon 806 allows the user 114 to navigate to the webbxchange.com screen for the user 114. This information is detailed in section 402 found in FIG. 4.

The logout icon 807 allows the user 114 to navigate to the webbchange.com screen 101. User 114, therefore, is logged out of the system and must log in again.

The category icons 808 allow the user 114 to enter into category-specific pages. Category pages reflect the collective information provided by webbchange.com users about a specific coin category. For a given category, this will display information such as top sites, top new sites, top tags, top new tags, top gaining sites, top sites by medium, top sites by location, top sites by various demographics or interest group, the amount of change given to a category, the amount of users contributing to the category, financial information such as the average allocation amount of that category coin, category amounts over time, and other information collected from the webbchange.com user base. Users may also access the Webbglobe from this page. The Webbglobe is accessible from many areas on webbchange.com and shows where concentrations of user information are coming from around the world on a globe or world map. Users may also dig into the Webbglobe to see the top sites and other information in certain areas related to a category or even a complex search, which may initiate from the search page 205 or elsewhere in webbchange.com.

The user boards 809 allow the user 114 to see relevant groupings of URLs based on the user board topic. User boards may be grouped by category, interest, or various other combinations, which strive to be relevant to the individual user 114, based upon the user demographics. One method for accomplishing this is that user profile information (demographics, interests, WEB browsing activity, etc.) can feed into the user boards to create an array of boards that are most applicable to their personality and interests. User boards also reflect the top sites in major categories distinguished on webbchange.com as well as “top new sites” and the top “gaining” sites over a specific period of time. Correlations between sites are established due to user interests, tags, and mediums, which allow for further individualized boards for each user 114. Examples of these are illustrated in FIG. 8.

The URL link 811 allows the user 114 to link to that URL from webbchange.com in either another window or within the webbchange.com platform.

The URL profile link 812 allows the user 114 to link to a profile that contains all the user info on that specific URL. The URL Profile, or Site Profile, is based upon the concept that just as each user has a profile, each website also has a profile that tells about how it is functioning on the WEB. Any site's profile can be linked to/from any board. (Users have the option to link directly to the site or go to their site profile). Users also may look up site profiles from the search page 205. Site profiles show how many people have invested coins into the site, how many coins, what types of coins, ratios that express the strength of the site, or specific categories or characteristics of that site. Site profiles show this information graphically and numerically, change over time, the duration the site has been around, and how long it has been on webbchange.com. The sites can have subsections that explain what the website is about, who owns it, its purpose, and so forth. Also, users may see what demographics or interests have given coins to the site, what categories of coins, and have capabilities to compare site profiles graphically to better analyze the differences and similarities in sites. Users also are able to see how the site has changed in real time and see on Webbglobe exactly where the user base exists. Site profiles, like user profiles, continue to grow and morph in nature and capabilities over time in connection to user needs.

Typical Screen from the Profile Process

As part of the account creation process 201, the user 114 is prompted to populate their user account 211 with data regarding their profile: demographics, interests, etc. Once the user 114 has an account with webbchange.com 101, their entry into the Internet site home page is via the login process 305 to a “My Home” page 202 at step 306, through which the user 114 can access their profile through profile icon 803 to update the data contained therein.

FIGS. 9A-9D illustrate graphic examples of typical screens from the profile process of the present WEB Site Valuation System.

FIG. 9A illustrates the Basic Information section of the profile, which can be accessed by clicking on icon 901—Basic Information. In this section, a user 114 may fill out or update their personal information by clicking on the Edit icon 9010, which causes the fields in the About Me section 9011 to become writable so that a user 114 can populate or change various data fields. The basic information includes the user's name, e-mail address, nickname, city and state of residence, and the like. A user may also go through the process of changing their password by clicking on the Change Password icon 9012. Additionally, from the basic information section of the profile process 203, a user 114 can access the Network section 9013 and search for a network by typing the network into data field 9014, and join a highlighted network by clicking Join Network icon 9015. Furthermore, user networks are shown in the User Network section 9016, and a user may access their network page, which populates and displays an array of information very similar to the information on the User Homepage 202, coin category page, or the webpage profile page, by clicking on icons 9017a or 9017b. Users may also edit mandatory information in their network by clicking Edit Info icon 9018 or leave a network by clicking icon 9019. A user is only allowed to join a limited amount of networks to ensure a user isn't simply joining many networks to have their information shown disproportionately within the WEB. This encourages honest choices of user networks. Webbchange.com users may have webbchange.com networks and, therefore, network pages that reflect other social networks they are a part of such as Facebook®, MySpace®, Twitter®, and Friendster® to name a few.

FIG. 9B illustrates the Personal Information section of the profile, which can be accessed by clicking on icon 902—Personal Information. In this section, a user 114 may fill out or update information pertaining to a variety of fields (including, but not limited to, ethnicity, education level, occupation, religion, languages spoken, exercise level, etc.), which populate section 9020. Underneath Field Categories 9021 are pre-populated drop boxes 9022 from which a user can identify their personal information. Additionally, if a user cannot find a selection in the drop down boxes 9022, they may click in the Add It icon 9023 to either search the webbchange.com database for their desired “distinction” or may submit the “distinction” to webbchange.com so that it might be added into the user database as an option. A user 114 may save or cancel their data entries by clicking the Save icon 9024 or the Cancel icon 9025. The Personal Information section is also where a user 114 may take various tests, quizzes, surveys, and the like, to continue to populate their profile, the webbchange.com database, and WEB Site Valuation System with quality information that can be used for searches, to populate user homepages, provide relevant advertising, gifts from the surprise box, and any other advantage or capability that information may provide.

FIG. 9C illustrates the Interests section of the profile, which can be accessed by clicking on icon 903—Interests. In this section, a user 114 may choose what interests provided in Available Interests section 9030 should populate their My Interests section 9031. A user may browse through the Categories of the Available Interests section 9030 and, by clicking on the interest(s), the user may then click on the Add icon 9032 to populate the My Interests section 9031. A user may remove an interest from the My Interests section 9031 by highlighting that interest or a group of interests and clicking the Remove icon 9033, which moves the interests back to the Available Interest section 9030. If a user cannot find an interest, they may click on the Add It icon 9023 to either search the webbchange.com database for their desired interest or may submit the interest to webbchange.com so that it might be added into the user database as an option. By sequentially selecting interests and populating the profile, the user 114 can provide the WEB Site Valuation System with data that can be used to match the user 114 and the WEB sites they select with statistics of user interests which can be used by advertisers and WEB site managers to target their audience. Users also are able to elaborate on their particular interests by defining more specific and topical interests like “Calvin and Hobbes, Indian Food, Kelly Clarkson, The Office, etc.” to further enrich data to the database which is linked to the WEB Site Valuation System. Additionally, users may weight the degree (or strength) of an interest they have which allows a user 114 better to find information based on the degree by which other users are interested in a particular interest. This also allows the WEB Site Valuation System to better populate the user homepage 202 with relevant user boards. This also makes user coins more valuable, as there is more detail and meaning behind each coin and opinion.

FIG. 9D illustrates the Settings section of the profile, which can be accessed by clicking on icon 904—Settings. The Settings section acts as the virtual construction zone for a user to tailor their homepage 202. The user may manipulate homepage content in the form of boards, tickers, graphs, watch lists, and advertising, change the look of their User Interface, or change their Webb Buddy, which acts as an avatar and information source for the user.

In the Settings section 904, a user 114 also is able to format Big Boards and User Boards into their profile. User Boards are “top 10” or “top 20” lists of sites relevant to the user 114, which selection of sites is based upon the user's interests. User Boards are both user-constructed boards based upon user interests and canned boards that the WEB Site Valuation System 100 makes to create a constantly changing atmosphere on the user homepage. These boards are based not only on the user profile demographics and interests/sociographics, but also based upon searches, others users like them, and other relevant logic used throughout the WEB Site Valuation System 100. Big Boards are top 10, 20, 100 boards that reflect mainstream categories or industry standards within the community of users on WEB Site Valuation System 100. Essentially, these are “canned” reports that can be seen within the user profile if desired by the user.

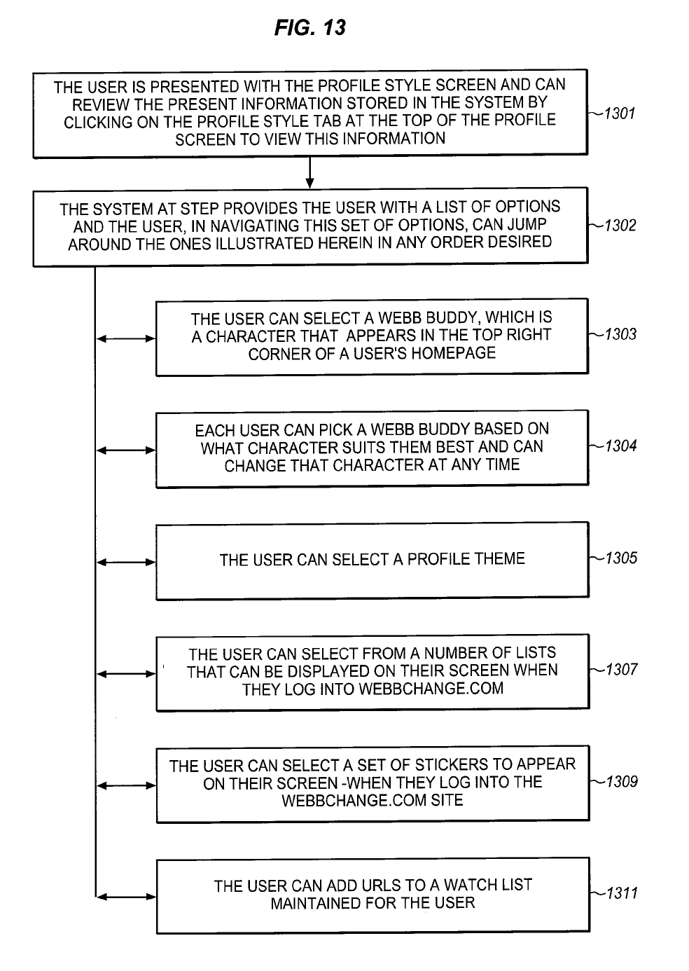

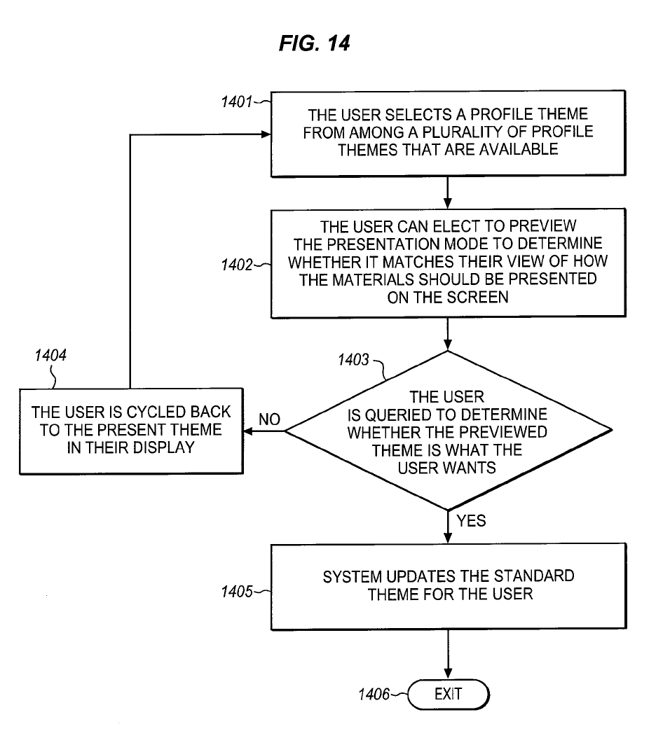

FIGS. 13 and 14 further illustrate, in flow diagram form, the operation of tailoring the home page process from the Setting section 904 of Profile section 203.

At step 1301, the user 114 is presented with the Profile Style screen and can review the present information stored in the system by clicking on the Profile Style tab at the top of the profile screen to view this information. The system at step 1302 provides user 114 with a list of options, represented by steps 1303, 1305, 1307, 1309, 1311 as described below. The user, in navigating this set of options, can jump around the ones illustrated herein in any order desired.

At step 1303, the user 114 can select a Webb Buddy, which is a character that appears in the top right corner of a user's homepage. Each user can pick a Webb Buddy at step 1304 based on what character suits them best and can change that character at any time. The Webb Buddy acts as an agent of communication with the user from webbchange.com. It tells the user when they receive new surprises in the Surprise box, when the interface may change, and what is generally going on within the webbchange.com community.

At step 1305, the user can select a profile theme. As shown on FIG. 14, at step 1401 the user 114 selects a profile theme from among a plurality of profile themes that are available. This theme is a presentation mode, so at step 1402 the user 114 can elect to preview the presentation mode to determine whether it matches their view of how the materials should be presented on the screen. The user 114 is queried at step 1403 to determine whether the previewed theme is what the user 114 wants. If not, at step 1404 the user is cycled back to the present theme in their display and can elect to exit 1406 and return to the selection process 1401. If the user 114 accepts the previewed theme, at step 1405 the system updates the standard theme for the user 114 and exits at step 1406.

At step 1307, the user can select from a number of lists that can be displayed on their screen when they log into webbchange.com. These lists include Compatibility Lists, which are generated by webbchange.com through various algorithms that show users other sites they might like based on the sites they like and other users like them also like. This is logically similar to other people you might be friends with on Facebook®, or how music is selected and dictated on Pandora®.

At step 1309, the user 114 can select a set of Tickers to appear on their screen when they log into the webbchange.com site. Tickers are like the stock market tickers that you see on financial websites or the New York Stock Exchange. However, instead of stocks, they display how sites are trending based upon user opinion. Various tickers can show various categories or sites, such as FUN, Hope, News, Information, Philosophy, Sports, etc. A ticker can also show what sites are doing well that have just arrived on the WEB in the last 24 hours, week, month, and so forth. Tickers may also show how the top 100 sites are doing on a day-to-day basis, or a ticker may just show how sites a user has invested money in are doing. Other types include tickers that show top sites based on tags, mediums, interests, demographics, etc. Thus, the various types of tickers can be chosen and changed, if not created within the user profile.

At step 1311, the user 114 can add URLs to a watch list maintained for the user 114. Watch lists are like tickers but can be done in list form for 10 sites, 20 sites, and so forth. A user 114 may also create a watch list made up of specific sites they would like to watch from their user homepage. Users may embed graphs of particular site information or groupings of sites as another way to watch activity on webbchange.com that is interesting and relevant to them.

Typical Screen from the Portfolio Process

The user 114 can also access the portfolio process 204, which enables the user to create a portfolio of URLs, which the user 114 accesses on a regular basis. This portfolio process 204 also enables the user 114 to allocate credits to the URLs listed in this portfolio.

FIGS. 10A and 10B illustrate a graphic example of a typical screen from the portfolio process of the present WEB Site Valuation System. The User Portfolio icon 804 navigates the user to the portfolio page 1000 which acts like a stock portfolio, which allows the user 114 to allocate credits to URLs, label the medium of a URL, tag URLs, see their personal history of allocating credits, and how user allocations have changed over time, not only in category type but to what URLs the credits have been allocated. Additionally, users can click on and click off different types of credits to review all different credits in all different combinations or all alone.

A user 114 can also further tag Internet sites in their portfolio as well as distinguish or change the medium of a URL that they have allocated coins toward. The “medium” of a URL helps sort URLs by distinctions such as website, article, video, music, literature, blog, people, and other “types” of mediums that occur as the WEB continues to change and evolve into the future. This use of medium has a direct impact on the searches conducted in the webbchange.com search engine, which can be linked to by Search icon 805. The portfolio 804 might also show trends of sites, update notification, charities on the rise, large changes in majority of one type of credit to another, or a popular tag addition.

FIG. 10A shows how a typical portfolio page might work for the user 114. Icon 1001 allows the user to add a site to their portfolio, which brings them to the process shown on FIG. 10B. Icon 1002 allows the user to delete an existing site that has been selected. Options in section 1003 allow a user to select all sites or just selected sites for deletion. Icon 1004 allows a user to reset their allocations of coins while leaving all information about a URL in their portfolio. Options in section 1005 allow a user to select all sites or just selected sites for resetting. Section 1006 shows the standard information for a URL in a user portfolio. A user may click on the link, see the types of coins, how many coins, the medium, and tags given to the URL in this section. Section 1007 allows the user to filter, expand, and contract their portfolio information based upon what they would like to review, delete, or edit. Returning to the process of adding a side as initiated by clicking on icon 1001, a user is given a screen 1008 illustrated in FIG. 10B. This process of adding a site is the same whether accessing it from the user portfolio 204, the browser plug-in 207, or when clicking on a link from a third party site. (When attempting this process from the browser plug-in or the third party site, a user must have an account and be logged into their webbchange.com account to allocate any coins). The screen 1008 acts as a virtual check for allocating a user's coins. In section 1009, the URL is entered or pre-populated from the site the user is accessing the virtual check from. Section 10010 allows the user to select the URL medium, section 10011 allows the user to tag the site, section 10012 allows the user to assign a coin category which they match with a coin amount in section 10013, and submit by clicking the icon 10014—Spend Coins. A user may make different submissions for different coin types, which allows the user to break up and analyze exactly in what proportions and how they view the worth of a particular site. This is unique to webbchange.com. Section 10015 shows how the user has spent their coins on various categories for this transaction, and the total of those coins appears in section 10016. The user's nickname appears in the signature section 10017 of the virtual check. The user completes the transaction by clicking the save button 10018, bringing the user back to the portfolio page illustrated in FIG. 10A, or the page they were at when they accessed the browser plug-in 207 or the third party website. When a user makes any submission or change, it is dated to show how current a submission is. This will allow for filtering of information by date/time, which is very relevant and useful criteria in the Web Site Valuation System, as new data shows how current and strong, or weak, or reactionary information might be for a particular site or within webbchange.com. It also give an impression to users the regular updates on their opinions are normal and encouraged at webbchange.com.

Additionally, users may also say when they would like a submission in their portfolio to expire after a certain time allowing the user to denote a relevance of time to their opinion. This might be particularly useful when URLS are current events, seasonal, or limited in the duration of its content being relevant to the user base. A user might also want a portion or all of their change to expire after a certain time to coincide with the frequency of how often they may spend their coins. For instance, perhaps a user always spends their coins on articles they find interesting, and simply want any allocation of coins to last for a month before expiring. This is useful not only to the user for convenience purposes, but also helps keep the Web Site Valuation System current and relevant to the user base.

Typical Screen from the Search Process

FIG. 11 illustrates a graphic example of a typical screen 1100 from Search Engine process 205 of the WEB Site Valuation System 100. The search engine allows users of webbchange.com to search and filter through the data on webbchange.com by any and all of the information collected in the Web Site Valuation System 100. It also has various features to make search results more relevant and pinpointed to a user's wants and needs. Section 1101 allows a user to specify a category or number of categories to search by. Section 1102 allows users to define an age range by which to search. Section 1103 allows users to distinguish a sex/gender by which to search. Section 1104 lets users search by network(s). Section 1105 allows a user to define tags they would like to search. Section 1106 allows users to search by Personal Information included in the Profile section 203. Section 1107 allows users to search by interests/sociographics included in Profile section 203. Searches may include any or all of these sections as criteria by which to access the desired results, which is populated in section 11010. Section 11010 may also be filtered to order results by number of coins, type of coin, number of tags, “new sites”, top gainers, recent allocations in the past week, month, year, etc. Additionally, users may specify that they would like only sites that are a particular medium by clicking on any of the icons represented in section 1109. These icons continue to populate over time as the WEB spreads to different types of mediums such as television, movies, personal sites, business, recipes, albums, etc. By clicking on icon 1108 to initiate a search, a user gets the top sites based on all mediums. A user may clear search results by clicking on the Clear Search Results icon 11011. The search engine also has advanced search options to either better pinpoint relevant results by defining characteristics of the sites, the users, the time period, and any other data current in the Web Site Valuation System 100. Additionally, users may create standard search criteria so that they do not need to fill out their search requirements every time. For instance, a user may want one of their standard searches to always search based on men between the ages of 20 and 40 who have above a high school degree, are from Australia, are Geminis, play basketball, and consider themselves experts at business. Users may also be able to create watch lists or tickers based off this system of searching and creating queries to get the results desired.

### Third Party Link to Webbchange.com

Just like many social book-marking and social networking sites have icons embedded into websites throughout the WEB, the third party link to webbchange.com acts in this manner. A webmaster may come to webbchange.com and create a third party link to embed in their site. This allows any webbchange.com user to click on that icon/link and allocate some of their webbchange.com tokens to that particular site or URL location. It also directs those who are not webbchange.com users to webbchange.com 101 to create an account and become a part of webbchange.com. This acts as advertising for webbchange.com but also allows sites to become better known on the WEB through the webbchange.com platform. This creates value for both the webmaster and the webbchange.com Web Site Valuation System by ensuring quick, easy access and allocation of worth through the webbchange.com token economy system.

### Advertising

Webbchange.com offers personalized advertising on a user's homepage based off of demographics, sociographics/interests and with a firmer emphasis, location, age, and gender, to create relevant pinpointed user advertising based upon who they are and where they are as people. Furthermore, these ads can be crossed out as “liked” or “disliked” with perhaps a system of explaining why they “liked” or “disliked” the ads, and also make it to where the ads do not reappear for a user for a set period of time (i.e., two months) on the first dislike, longer (i.e., four months) for the second, longer for the third, and so forth.

Conversely, liked ads cause a correlation between the user and certain types of ads so that ads similar to it become more prevalent but not dominating to allow for some mix to give a constant sense of “newness” to the user. Additionally, ads may fade in and out after a few seconds to make it seem more interactive to the user. Thus, the WEB Site Valuation System 100 allows users to ask for certain types of advertising, thereby improving the advertising model of the WEB Site Valuation System 100.

Advertising while searching is a bit different. While there is an element of personalization based on demographics and sociographics, there is also a better focus on what is being searched on in relation to the ads, whether this is by the category of change, or a specific word or tag. As a user searches deeper or with more detail, the ads have the ability to be more detailed; also there is a certain hierarchical structure that dictates not only what ads go where, but also the pricing of those ads, which is detailed further in Advertising Administration. Furthermore, when on a category page, network page, or site profile page, advertising will reflect the nature of that particular page to fit with the information present on each page and the user demographics and sociographics/interests visiting that page.

As far as placing/ordering advertising, this is done both from a user perspective, small business owner perspective, or a large corporate perspective. WEB Site Valuation System 100 tailors this by the size of the ad campaign, the nature of the ad, and the detail of the search. The goal of webbchange.com is to provide all entities from all levels to participate in the many levels and facets of the WEB Site Valuation System's advertising model.

### Surprise Box

Surprise Box is where users receive free gifts from advertisers, webbchange.com, and any other source. This is a unique concept to Webbchange.com since it is dependent on the user base to generate cash flows from advertisers, and advertisers have the unique ability to tailor their marketing campaigns through the system to the user base. Therefore, users are rewarded and fuel continued use through a system of positive reinforcement (i.e., free stuff). Advertisers pay to use the system for pinpointed advertising with relevant feedback from webbchange.com; and from that service, as part of their payment, advertisers are required to distribute free relevant products or services to users or provide free money for users in the form of cash give-a-ways from their business and webbchange.com. Distribution of these items is random and aim at reaching users who truly value the gift. Webbchange.com also rewards users through cash prizes and any other gifts. The Surprise Box is not always on the site, but pops up when there are new gifts. The Surprise Box does not always look the same to reflect the concept of a new present, courtesy of webbchange.com.

### Webbchange.com Give-A-Polooza

The webbchange.com Give-A-Polooza is an annual cash give-away to webbchange.com users. All users are eligible for this event if they have updated their profile and portfolio information by a given deadline. This is meant to reward users who make webbchange.com possible and to maintain current information on webbchange.com. It also promotes the value of giving, which is core to the webbchange.com concept.

### Webbchange.com Treasure Hunt

In addition to the advertising models and strategies listed previously, webbchange.com also acts on a unique model of advertising, which is contained in the webbchange.com Treasure Hunt. This model encourages users to participate in a scavenger hunt throughout the WEB and is sponsored by advertisers whose sites webbchange.com is directing traffic to due to the clues and nature of the Treasure Hunt. Essentially, the sites involved in the treasure hunt agree to embed a set amount of tokens somewhere on their webpage, and webbchange.com directs users to their sites through various clues, puzzles, riddles, etc. (From this point forward, numbers are meant to explain the process of determining a winner and may vary depending on user base, advertising agreements, and nature of the game.) On the first level, 100% of users will be directed toward a set number of sites to try and find the hidden token(s) on philanthropy or “cause” based sites. Of that 100%, only 80% of users are able to receive the limited amount of tokens available to collect on those particular sites on the first level (LEVEL 1) of the treasure hunt. A user is verified because they can only collect a token if they are logged into their webbchange.com account. When they receive the token, the webbchange.com system provides the next clue, puzzle, riddle, etc. and the next appropriate time. This then leads that 80% of users move to LEVEL 2 sites which have paid a particular price to exist on that level of the treasure hunt. (Different sites on different levels may pay more or less based on the amount of tokens they have to give to users and, thus, the amount of traffic that is fueled to their site.) Once all tokens on LEVEL 2 have been collected (or time runs out to complete that stage of the treasure hunt), 80% of the 80%, or 64% of the original users playing the game, are given clues, riddles, puzzles, etc., to find tokens on LEVEL 3 who pay for the advertising and site traffic similar to other levels. At each level, the amount of users playing become less and less, until there is ONE grand prize winner and a few smaller winners, who get the Grand prize of the webbchange.com Treasure Hunt. This system of advertising is unique to webbchange.com not only in its model but in that it promotes all that webbchange.com is meant to promote: web exploration, user rewards, promotion of charity and causes, and just plain fun.

### Bags of Webbchange Advertising Model

Another unique advertising idea to webbchange.com is the Bags of Webbchange Advertising Model. Also in line with promoting fun, giving back, and the use of currency, the method of advertising through Bags of Webbchange is a unique and original promotional campaign by webbchange.com. This system of advertising is simply leaving bags of money in bags marked “Webbchange” around towns, colleges, restaurants, bars, libraries, anywhere, to promote webbchange.com. Who doesn't like bags of cash? Essentially, when webbchange.com starts to spread into a new community, network, school, etc., webbchange.com may choose to excite that particular audience by leaving mystery bags of coins (Webbchange bags of money) for people to find. It connects the user to our new currency system by providing them currency, promotes a message of giving back, and is just plain fun.

### Webbxchange.com and Its Operation

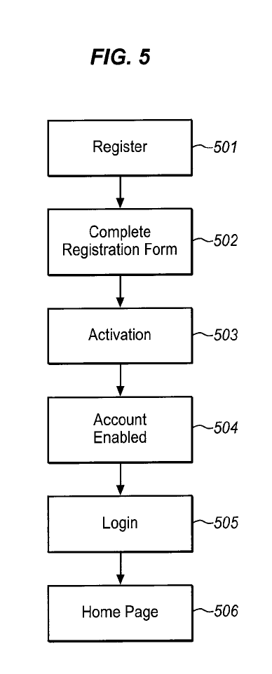

FIG. 4 illustrates, in block diagram form, the architecture of the webbxchange.com 102 segment of the present WEB Site Valuation System 100; and FIG. 5 illustrates, in flow diagram form, the operation of the user registration process of the webbxchange.com segment 102 of the present WEB Site Valuation System 100. The WEB Site Valuation System 100 includes a number of functional elements, and FIG. 4 illustrates those used with respect to the wwww.webbxchange.com 102 WEB site.

The webbxchange.com segment 102 of the present WEB Site Valuation System 100 is the representative stock market of the democratic, monetary, quantifying-quality platform. It exposes sites and their nature much like one would view the quality of a company in terms of stock prices. It reflects the change in Internet site value over time, the weight of value per individual user, as well as the different weights based upon differing categories. The Big Boards generated by this site help maintain structure in terms of industry standards and help organize the information into usable/analytical pieces that are of great use to advertisers, businesses, and users. Additionally, it is an open platform that shows Internet site owners what their competitor Internet sites are excelling at, or lacking, in comparison to their own. This fosters an environment of reacting to user opinion and perceived categories of value, which not only force Internet sites to be more competitive but also openly communicate that, for an Internet site to be successful, they must actually serve their user base. It is the hope that this new way of looking at this type of information levels the playing field in a number of different industries so that the big names are big because they provide a true service, not simply because they have the money to advertise over smaller companies or sites.

Thus, the users who have registered with webbchange.com 101 can automatically be members of webbxchange.com 102, since they would likely have interests in both Internet sites. However, Internet site managers and advertisers may not be registered on webbchange.com 101, and the following registration process addresses the opportunity for those individuals to become members of only the webbxchange.com 102 site. The two Internet sites are linked as shown on FIGS. 2 and 4 in order for the data input to and generated by the webbchange.com 101 site is available to the webbxchange.com 102 site for the generation of reports and for searching by members as is described below.

In particular, a user 115 can access the user interface 400 of this WEB site 102 via a communication medium 140 in the standard manner and, if the user is a first time user, navigate to the new user create and activate process 401. This new user create and activate process 401 creates an account for the user 115 in the webbxchange.com 102 domain and can use the e-mail address of the user 115 as their unique identifier, as described below. As part of the account creation process, the user 115 is prompted to populate their account with data regarding their preferences: demographics, interests, etc. Once the user 115 has an account with webbxchange.com 102, their entry into the WEB site is via the login process 402 to a “My Home” page, through which the user 115 can access their preferences to update the data contained therein.

FIG. 5 illustrates, in flow diagram form, the operation of the new user create and activate process 401 of the present WEB Site Valuation System 100. At step 501, the user 115 can access the webbxchange.com 102 WEB site via a communication medium 140 in the standard manner and, if the user 115 is a first time user, the user 115 clicks on the New User icon to navigate to the New User create and activate process 401. This process 401 at step 502 creates an account for the user 115 in the webbxchange.com 102 domain. The New User create and activate process 401 presents the user 115 with a registration page that includes a combination of mandatory data entry fields and optional data entry fields. As part of the process of creating a new user login and profile, the user 115 is requested to create a unique login and password. For example, the user 115 can use their e-mail address as their unique identifier. In addition, the user 115 may be required to validate a randomized, alphanumeric string which is presented as an image (as described above with respect to webbchange.com).

Once the user 115 completes the registration form, the user 115 receives an e-mail from webbxchange.com 102 that contains an activation link or code. The user 115 cannot log into the user's account on webbxchange.com 102 until the account has been activated by the link, code, or trusted third party mechanism (such as biometric scanning) which is executed at step 504. Upon activation of the user account using the account enabling process of step 504, the user 115 receives a follow-up notice from webbxchange.com 102 informing them that their account has been activated and they can now log into their account and start using the application. At step 505, the user 115 can log in to webbxchange.com 102 using their unique login and password to reach the home page 402 at step 506 through which the user 115 can access their preferences to update the data contained therein.

What is claimed as new and desired to be protected by Letters Patent of the United States is:

1. A method for determining a measure of value provided to Internet users by selected Internet sites comprising:
maintaining user accounts for a plurality of users, each of said user accounts providing an associated user with credits that can be assigned by said user to a selected Internet site as an assessment by said user of a value of said selected Internet site;
transferring, in response to a user assigning credits from said user account to a selected Internet site, said assigned credits from said user account to an Internet site account associated with said selected Internet site; and
tabulating credits assigned to a plurality of Internet sites by users, said tabulated credits being indicative of a value of a selected Internet site to said users.

2. The method for determining a measure of value provided to Internet users by selected Internet sites of claim 1, further comprising:
maintaining a plurality of Internet site accounts for receiving said assigned credits.

3. The method for determining a measure of value provided to Internet users by selected Internet sites of claim 2, further comprising:
credit assigning means for assigning a predetermined number of credits to each of said users as each of said users executes a user registration process.

4. The method for determining a measure of value provided to Internet users by selected Internet sites of claim 3 wherein said step of transferring assigns credits to each of said users for completing each of a plurality of steps of said registration process.

5. The method for determining a measure of value provided to Internet users by selected Internet sites of claim 3 wherein said step of transferring assigns an equal number of credits to each of said users for completing said registration process.

6. The method for determining a measure of value provided to Internet users by selected Internet sites of claim 1, further comprising:
display means for transmitting data to said user communication device from said Internet site valuation means indicative of credit assignment activity of said plurality of users.

7. The method for determining a measure of value provided to Internet users by selected Internet sites of claim 6, further comprising:
display means for transmitting ticker data, indicative of credit assignment activity of said plurality of users, to said user communication device from said Internet site valuation means for display in ticker format on a screen of said user communication device.

8. The method for determining a measure of value provided to Internet users by selected Internet sites of claim 1, further comprising:
credit transfer means, responsive to said user reassigning credits previously assigned by a user to a selected Internet site to a newly selected Internet site, for transferring said reassigned credits from an Internet site account assigned to said selected Internet site to an Internet site account associated with said newly selected Internet site.

9. The method for determining a measure of value provided to Internet users by selected Internet sites of claim 1, further comprising:
gift means for maintaining data associated with said user accounts indicative of free products and services that are available to a user of said user account.

10. The system for determining a measure of value provided to Internet users by selected Internet sites of claim 9, further comprising:
transferring, in response to user activity associated with a user account, selected data indicative of free products and services to said user.

11. The system for determining a measure of value provided to Internet users by selected Internet sites of claim 1 wherein said user account means comprises:
maintaining user profile data indicative of a set of demographic, socio-graphic, and user preference characteristics of said users.

12. The method for determining a measure of value provided to Internet users by selected Internet sites of claim 11, further comprising:
maintaining data associated with said user accounts indicative of advertising for products and services that are available to a user of said user account.

13. The method for determining a measure of value provided to Internet users by selected Internet sites of claim 1 wherein said step of maintaining user accounts comprises:
maintaining data in a user profile indicative of a set of demographic, socio-graphic, and user preference characteristics of said users.

14. The method for determining a measure of value provided to Internet users by selected Internet sites of claim 13, further comprising:
maintaining data associated with said user accounts indicative of advertising for products and services that are available to a user of said user account based upon said set of demographic, socio-graphic, and user preference characteristics stored in said user profile.

15. The method for determining a measure of value provided to Internet users by selected Internet sites of claim 13, further comprising:
displaying at least one listing of WEB sites on said user communication device as derived from said user profile data.

16. A method for determining a measure of value provided to Internet users by selected Internet sites comprising:
maintaining, on a server which is connected to the Internet:
user accounts for a plurality of users, each of said user accounts providing an associated user with credits that can be assigned by said user to a selected Internet site as an assessment by said user of a value of said selected Internet site, and
a plurality of Internet site accounts for receiving said assigned credits; and
tabulating, on said server, said credits assigned to a plurality of Internet sites by users, said tabulated credits being indicative of a value of a selected Internet site to said users.

17. The method for determining a measure of value provided to Internet users by selected Internet sites of claim 16, further comprising:
transmitting, in response to a user who is connected to said Internet via a user communication device assigning credits from their user account to a selected Internet site, data to said server indicative of said transfer.

18. The method for determining a measure of value provided to Internet users by selected Internet sites of claim 16 wherein said step of maintaining further comprises:
transferring, in response to said transmitted data received from said user communication device, credits from their user account to an Internet site account corresponding to said selected Internet site.

19. The method for determining a measure of value provided to Internet users by selected Internet sites of claim 16 wherein said step of maintaining further comprises:
assigning a predetermined number of credits to each of said users as each of said users executes a user registration process.

20. The method for determining a measure of value provided to Internet users by selected Internet sites of claim 19 wherein said step of assigning assigns credits to each of said users for completing each of a plurality of steps of said registration process.

21. The method for determining a measure of value provided to Internet users by selected Internet sites of claim 19 wherein said step of assigning assigns an equal number of credits to each of said users for completing said registration process.

22. The method for determining a measure of value provided to Internet users by selected Internet sites of claim 17 wherein said step of maintaining further comprises:
transmitting data to said user communication device from said server indicative of credit assignment activity of said plurality of users.

23. The method for determining a measure of value provided to Internet users by selected Internet sites of claim 22, further comprising:
transmitting ticker data, indicative of credit assignment activity of said plurality of users, to said user communication device from said server for display in ticker format on a screen of said user communication device.

24. The method for determining a measure of value provided to Internet users by selected Internet sites of claim 17 wherein said server further comprises:
transferring, responsive to credit reassignment data received from said user communication device, for transferring said reassigned credits from an Internet site account assigned to said selected Internet site to an Internet site account associated with said newly selected Internet site.

25. The method for determining a measure of value provided to Internet users by selected Internet sites of claim 16, further comprising:
maintaining data associated with said user accounts indicative of free products and services that are available to a user of said user account.

26. The method for determining a measure of value provided to Internet users by selected Internet sites of claim 25, further comprising:
transferring, in response to user activity associated with a user account, selected data indicative of free products and services to said user.

27. The method for determining a measure of value provided to Internet users by selected Internet sites of claim 16 wherein said step of maintaining comprises:
maintaining user profile data indicative of a set of demographic, socio-graphic, and user preference characteristics of said users.

28. The method for determining a measure of value provided to Internet users by selected Internet sites of claim 27, further comprising:
maintaining, in response to said user profile data, data associated with said user accounts indicative of advertising for products and services that are available to a user of said user account.

29. The method for determining a measure of value provided to Internet users by selected Internet sites of claim 27, further comprising:
displaying at least one listing of WEB sites on said user communication device as derived from said user profile data.
